(19) United States
(12) Patent Application Publication
(10) Pub. No.: US 2018/0326351 A1
(43) Pub. Date: Nov. 15, 2018

(54) PROCESS FOR TREATING FLUE GASES RESULTING FROM A COMBUSTION OR CALCINATION FURNACE AND PLANT FOR THE IMPLEMENTATION OF SUCH A PROCESS

(71) Applicants: FIVES SOLIOS INC., Montreal (CA); FIVES SOLIOS, Le Pecq (FR)

(72) Inventors: Thierry ALLEGRUCCI, Montreal (CA); Chin LIM, Le Vesinet (FR); Philippe MARTINEAU, Montreal (CA)

(21) Appl. No.: 15/774,601

(22) PCT Filed: Nov. 22, 2016
(86) PCT No.: PCT/FR2016/053051

§ 371 Date: May 9, 2018

(30) Foreign Application Priority Data
Dec. 10, 2015 (FR) 15 62130

(51) Int. Cl. B01D 53/60; B01D 53/34; B01D 53/50; B01D 53/86

(52) U.S. Cl. CPC B01D 53/60; B01D 53/343; B01D 53/508; B01D 53/8631; B01D 53/346; B01D 2251/2062; B01D 2258/0283; B01D 2251/602; B01D 2257/2045; B01D 2257/2047; B01D 2257/302; B01D 2257/404; B01D 2258/0233; B01D 2251/404

(57) ABSTRACT

A method for treating flue gas including sulphur oxides and nitrogen oxides includes: cooling the furnace outlet flue gas; contacting it with a sulphur oxide neutralization agent, reducing the sulphur oxides by desulphurization reactions, and obtaining residues; separating the residues from the flue gas; reheating the flue gas; injecting a nitrogen oxide neutralization agent therein; and placing the reheated flue gas and the nitrogen oxide neutralization agent in contact with a catalyst, reducing the nitrogen oxides by denitrification reactions, the cooling of the flue gas achieved by reheating, inside the same heat exchanger, the flue gas separated from the desulphurization residues. The reheated flue gas is mixed, after injecting the nitrogen oxide neutralization agent, with the flue gas cooled after being placed in contact with the sulphur oxide neutralization agent, the separation of the residues and the contact with the catalyst being carried out inside a single separation device.

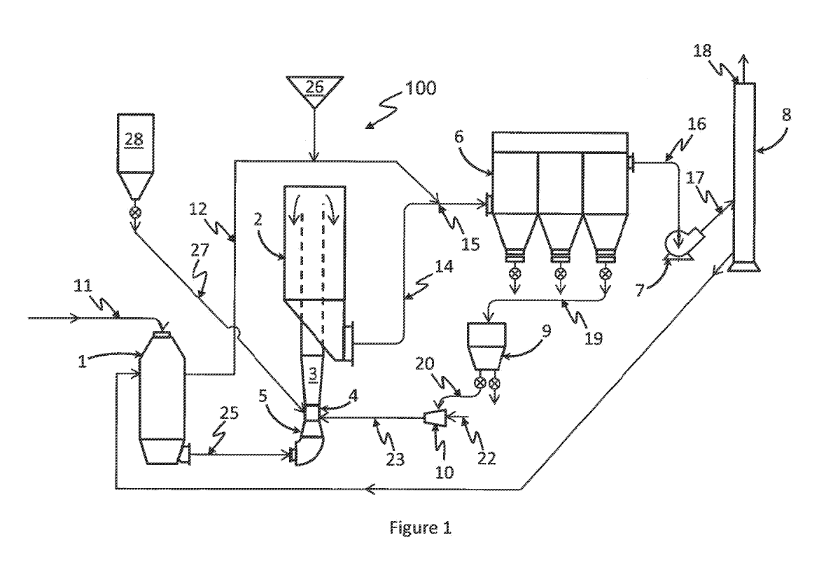

The present invention relates to a method for treating the pollutants contained in flue gas. In particular, the technology presented herein consists mainly of treating sulphur oxides—such as sulphur dioxide (SO₂)—by a so-called desulphurisation process (DeSOx), and nitrogen oxides—such as nitrogen oxide (NO) and nitrogen dioxide (NO₂)—by a so-called denitrification process (DeNOx). The flue gas to be treated mainly comes from combustion sources such as combustion furnaces or coal-fired boilers, or from a furnace or a calcination process for cement production, lime production or any other calcination process.

Such flue gas contains one or more acid pollutants such as hydrochloric acid (HCl), hydrofluoric acid (HF), sulphur oxides (SOₓ) and nitrogen oxides (NOₓ), which can cause harm to the environment, for example via acid rain, if this flue gas is released into the atmosphere without an appropriate, effective treatment. It is therefore essential to have a method that ensures effective collection of these pollutants in order to be able to comply with environmental regulations.

Different technologies are known for providing desulphurisation and denitrification. However, these technologies are generally only effective for one of the pollutants (SOₓ or NOₓ) since the parameters of the method for treating the SOₓ and the NOₓ are different, including the temperature for neutralising same.

A widespread technology for treating sulphur dioxide (SO₂) is the so-called semi-wet process which consists of placing lime slurry, dispersed in droplet form, in contact with the flue gas in a reactor or in a cooling tower before passing same into a bag filter. However, this technology requires the temperature of the flue gas to be lowered very close to the dew point of the gases, in order to perform effective SO₂ capture. This leads to considerable water evaporation, expensive facilities and an increased risk of gas condensation.

In the case of treating NOₓ, two technologies are well known: SCR and SNCR. These two technologies use ammonia as a reagent. SCR (Selective Catalytic Reduction) technology uses a catalyst which thus makes it possible to neutralise the NOₓ at medium temperatures (around 350° C.), either in a reactor or in a filter. The potential problem with this technology is the contamination of the catalyst over time due to the presence of SOₓ in the flue gas, requiring it to be replaced after two or three years of operation. As for SNCR (selective non-catalytic reduction) technology, it consists of neutralising NOₓ at very high temperatures, around 850° C. to 1000° C., so that a catalyst is not necessary, but this is sometimes incompatible with the process. In addition, the NOₓ reduction performance is considerably reduced if the temperature range at the reagent injection point is not observed. Finally, the injection of excess ammonia into the reactor can cause the equipment located downstream to corrode and ammonia to leak into the environment.

The temperature range required for SNCR technology is incompatible with that required for desulphurisation. Therefore, SCR technology is preferred for combining with desulphurisation in the same facility. Moreover, in order to prevent SOₓ from contaminating the NOₓ neutralisation catalyst, desulphurisation is generally carried out before denitrification, so that the flue gas at a temperature suited to desulphurisation needs to be reheated prior to denitrification, which implies an energy consumption that drives up the costs of the flue gas treatment method.

Document EP 2 815 801 describes an example of such a facility, wherein the flue gas generated in a boiler is first sent into an SO₂ treatment unit and then into an SCR treatment unit. Between the two units, a compressor makes it possible to increase the temperature of the gas at the intake of the SCR treatment unit.

Such a facility does not provide full satisfaction, in particular since it requires considerable energy consumption in order to be able to modify the temperature of the flue gas. Indeed, at the outlet of the boiler, the temperature of the flue gas depends on the nature of the process inside the boiler—which can reach 1200° C. The flue gas should thus be cooled before entering the SO₂ treatment unit, and then reheated before entering the SCR treatment unit.

Thus, there is a need for a novel treatment method that makes it possible to ensure good effectiveness of SOₓ and NOₓ pollutant reduction by a single treatment system while overcoming the problems of the known methods.

For this purpose, according to a first aspect, the invention proposes a method for treating the flue gas from a combustion or calcination furnace comprising pollutant species that include sulphur oxides and nitrogen oxides. The method comprises the following steps:
cooling the flue gas at the outlet of the furnace,
placing the cooled flue gas in contact with a sulphur oxide neutralisation agent, in order to reduce the sulphur oxides by desulphurisation reactions, and to obtain residues of the desulphurisation reactions,
separating the residues of the desulphurisation reactions from the flue gas,
reheating at least one portion of the flue gas separated from the residues of the desulphurisation reactions,
injecting a nitrogen oxide neutralisation agent into the reheated flue gas,
placing at least the reheated flue gas and the nitrogen oxide neutralisation agent in contact with a catalyst, in order to reduce the nitrogen oxides by denitrification reactions, said cooling of the flue gas at the outlet of the furnace being carried out by reheating, inside the same heat exchanger, said at least one portion of the flue gas separated from the residues of the desulphurisation reactions,
   the method being characterised in that the reheated flue gas is mixed, after injecting the nitrogen oxide neutralisation agent, with the flue gas cooled after being placed in contact with the sulphur oxide neutralisation agent, the separation of the residues of the desulphurisation reactions and the placing in contact with said catalyst being carried out inside the same separation device.

The method thus makes it possible to clean the flue gas of sulphur oxides and of nitrogen oxides within a single facility while minimising energy expenditures, and the facility for performing the process is thus also compact.

The sulphur oxide neutralisation agent is, for example, lime. The nitrogen oxide neutralisation agent is, for example, ammonia.

According to one embodiment, when the cooled flue gas is brought into contact with the sulphur oxide neutralisation agent, the moisture inside the flue gas is monitored in order to optimise the desulphurisation.

A portion of the residues of the desulphurisation reactions can advantageously be recycled as a sulphur oxide neutralisation agent.

According to a second aspect, the invention proposes a facility for treating flue gas from a furnace, comprising sulphur oxides and nitrogen oxides, for performing the method as presented above, comprising a heat exchanger connected to the furnace in order to cool the flue gas exiting said furnace, a desulphurisation reactor connected to the heat exchanger, and in which the cooled flue gas is placed in contact with a sulphur oxide neutralisation agent in order to reduce the latter by desulphurisation reactions, a separation device, connected to the desulphurisation reactor, in which the residues of the desulphurisation reactions are separated from the flue gas, an injector of a nitrogen oxide neutralisation agent into at least one portion of the flue gas separated from the residues of the desulphurisation reactions, and a catalytic device for denitrification of the flue gas, the device for separating the residues of the desulphurisation reactions being connected to the heat exchanger so that said at least one portion of the flue gas from the device for separating the residues of the desulphurisation reactions is reheated by the flue gas exiting the furnace, characterised in that the device for separating the residues of the desulphurisation reactions and the catalytic device are combined in a single separation device, the reheated flue gas being mixed, after injecting the nitrogen oxide neutralisation agent, with the cooled flue gas exiting the reactor in an inlet duct of the separation device.

The separation device comprises, for example, at least one bag filter, a denitrification catalyst being distributed on the surface of the bags of the filter. As an alternative, the separation device comprises at least one bag filter, a denitrification catalyst being placed inside the bags of the filter.

Further advantages and characteristics will appear in the light of the description provided hereunder of an embodiment of a facility for carrying out the treatment method according to the invention, in reference to the FIGURE which diagrammatically shows the embodiment.

The single FIGURE shows a facility 100 for carrying out a method for treating flue gas from a combustion or calcination furnace. According to the embodiment presented herein, the facility is particularly suited to the treatment of flue gas from a furnace for producing lime, in which the acid gases contain, in particular, sulphur oxides (SOₓ) and nitrogen oxides (NOₓ).

The facility 100 comprises a heat exchanger 1 of a known type. The heat exchanger 1 has, for example, cooling pipes: the cooler fluid circulates inside the pipes, while the hotter fluid is in contact with the outer wall of the pipes. The heat exchanger 1 thus comprises two fluid-circulation circuits.

A first flow circuit of the heat exchanger 1, for example the flow circuit of the gases in contact with the outer wall of the cooling pipes, is connected to a duct 11 via which the hot flue gas from the furnace enters, and to a desulphurisation reactor 2, for example such as a Venturi, by a duct 25 for allowing the cooled flue gas to enter the reactor 2. The reactor 2 comprises an intake formed by the succession, in the circulation direction of the cooled flue gas, of a convergent nozzle 5, a neck 4 and a divergent nozzle 3. The reactor 2 is supplied with a sulphur oxide neutralisation agent. Said sulphur oxide neutralisation agent can be lime, sodium bicarbonate, magnesium carbonate, calcium carbonate, or a mixture of at least two of said products. Specifically, according to the example, the reactor 2 is supplied with new lime from a tank 28, which reacts with the sulphur oxides to form salts. The new lime is transported from the tank 28 to the neck 4 of the reactor 2 via a supply duct 27. As explained hereunder, the reactor 2 is also potentially supplied with recycled hydrated lime. It is important to monitor the moisture inside the reactor 2. Indeed, the moisture rate must be controlled enough to ensure that the lime behaves as a powder reagent, and does not agglomerate forming a paste. Moreover, the moisture must be monitored so that the evaporation of the water contained in the surface of the solid particles causes controlled cooling of the flue gas and encourages the absorption and neutralisation of the SO₂ and other possible acids (HCl and HF), while keeping the temperature of the flue gas away from the dew point thereof in order to avoid clogging problems. A maximum moisture rate of 10% by weight of lime has been deemed adequate. The desulphurisation reactions in the reactor 2 are thus carried out for a short residence time of the flue gas in the reactor 2. The residues of the reactions are generally solid salts, such as calcium sulphate (CaSO₃) as sulphur oxide residues, but also calcium fluoride (CaF₂) and calcium chloride (CaCl₂).

The facility 100 comprises a separation device 6, connected to the reactor 2 by an inlet duct 14 in a filter of the device 6, making it possible to separate the solid residues of the reactions—in particular of the desulphurisation reaction, in this case the formed salts and excess limes—from the gases. For this purpose, the separation device 6 comprises at least one bag filter made up of a plurality of filtration modules, through which the flue gas passes, the solid residues, and possibly the excess limes, being retrieved and directed towards a recycling tank 9 via a return duct 19. Moreover, the particles which are deposited on the surface of the bags of the filter in the separation device 6 form a cake of still-active hydrated lime particles forming an additional surface, which makes it possible to continue the neutralisation reaction of the acid gases inside the separation device 6 and further to increase the effectiveness of the method. Around 80-95% of the neutralisation reaction takes place in the reactor 2, and the rest takes place in the bags of the filter of the separation device 6.

As explained below, the bags of the filter are said to be catalytic, since they comprise a catalyst for the denitrification reactions. For example, the bags are covered on the entire surface thereof with a layer of a metal catalyst, which increases the surface for contact with the flue gas. However, the catalyst can be placed inside the bags.

The mixture in the recycling tank 9 is referred to as recycled lime. The recycled lime is in solid form, allowing it to be recovered easily. All or part of the recycled lime can be reused in the desulphurisation reactor 2. For this purpose, the recycled lime is conveyed by a duct 20 for transporting same to a humidifying drum 10, wherein water, in closely monitored quantities, enters via an inlet 22. The humidified recycled lime, without exceeding the maximum moisture rate of 10% by weight of lime, is then sent into the desulphurisation reactor 2 via a duct 23 connected to the neck 4 of the reactor 2 in order to react again with the acid pollutants in the flue gas.

The recirculation of the recycled lime in the reactor 2 makes it possible to maximise the gas/solid contact, for better use of the reagent and reduced dumping of residues.

The residues which are not recycled are dried, which facilitates the dumping thereof, or even the reuse thereof as a soil-treatment product. Thus, the main parameters to ensure high effectiveness in SO₂ neutralisation are mainly the stoichiometric excess of the hydrated lime supplied relative to the pollutants, the amount of recycled lime and the surface moisture thereof, which conditions the lowering of the temperature of the flue gas, as well as the active surface area (BET surface area) of the hydrated lime particles.

The flue gas at the outlet of the separation device 6 is then directed via a discharge duct 16 towards a fan 7. The latter makes it possible, in particular, to overcome the head loss suffered in the filters of the separation device 6. Next, the purified flue gas is conveyed from the fan 7 to a stack 8 via an outlet duct 17.

At least one portion of the flue gas separated from the residues of the desulphurisation reactions and arriving at the stack 8 is recirculated upstream from the process, to be cleaned of nitrogen oxides by the so-called SCR method.

Specifically, a portion of the flue gas in the stack 8 is returned to the heat exchanger 1, in the second flow circuit inside cooling pipes. Thus, the recirculated flue gas, separated from the residues of the desulphurisation reactions, is reheated by the hot flue gas entering into the first flow circuit of the exchanger 1, while the hot flue gas entering into the first circuit is cooled by the recirculated flue gas. The energy consumption required to bring the flue gas to an adequate temperature after the steps of scrubbing same is thus reduced.

The recirculated and reheated flue gas exits the heat exchanger 1 via a contact duct 12, separate from the inlet duct 25 of the reactor 2, and connected to a tank of a nitrogen oxide neutralisation agent, for example ammonia. Ammonia or urea or a mixture of these two products can be used as nitrogen oxide neutralisation agent. Specifically, the injector 26 of the nitrogen oxide neutralisation agent, in this example ammonia, is connected to the contact duct 12, so that the ammonia mixes with the recirculated and reheated flue gas in the contact duct 12.

The mixture of ammonia and recirculated flue gas is combined and mixed with the gas/solid mixture exiting the desulphurisation reactor 2 by the junction of the contact duct 12 and the duct 14 for intake into the filter of the device 6, and connecting the reactor 2 to the separation device 6 at a combination point 15.

After the combination point 15, the flue gas in the filter inlet duct 14 is then a mixture comprising, in particular:
flue gas having undergone a desulphurisation process in the reactor 2, but not yet separated from the residues of the desulphurisation reactions;
flue gas having undergone a desulphurisation process in the reactor 2, and separated from the residues of the desulphurisation reactions; and
ammonia.

This mixture then enters the separation device 6, at a temperature that is compatible with denitrification by the SCR method, and comes into contact with the catalyst of the bag filter. The denitrification reactions reduce the nitrogen oxides and the ammonia in the flue gas to the ionic form thereof so that they can be transformed mainly into gaseous nitrogen and water vapour. The separation device 6 then also acts as a catalytic device for denitrification.

The flue gas is then directed, as above, towards the stack 8, from which the non-recycled portion of this flue gas is discharged into the atmosphere via an opening 18.

The flue gas thus discharged has very low concentrations of pollutants, in compliance with environmental regulations.

One advantage of the method is that the residues recovered from the separation device 6—i.e. the salts (CaCl₂, CaF₂, CaSO₃)—are dry, and thus these residues can be reused in the market.

Another advantage is that, due to the minimal amount of water used to humidify the hydrated lime in the drum 10, there is no need to treat liquid effluents, which reduces the amount of equipment and potentially the maintenance and operation costs.

In addition, the arrangement of the equipment in the implementation of the method also has its advantages. For example, by placing the catalytic bag filters after the desulphurisation reactor 2, since most of the SO₂ is removed in the reactor 2, the risks of poisoning the catalyst in the filters of the separation device 6 are significantly reduced.

Another advantage provided by these filters is that catalyst particles can be deposited on the entire surface of the bags thereof, which increases the reaction surface for denitrification. Thus, the nitrogen oxides are capable of reacting over the entire length of the bags of the filters with most of the ammonia injected upstream from the filters, which prevents same from leaking into the environment. Likewise, this filtration makes it possible to achieve high effectiveness in the separation of the pollutants from the gases, since most of the constituents contained in the initial flue gas can be removed.

Finally, the method makes it possible to perform desulphurisation and denitrification of the flue gas within the same facility, thus reducing energy consumption. Indeed, the method makes it possible to circulate the flue gas from the furnace in two parallel circuits, namely a desulphurisation circuit and a denitrification circuit, and to adjust the temperature of the flue gas in each circuit, thus minimising energy consumption.

1. A method for treating flue gas from a combustion or calcination furnace comprising polluting species including sulphur oxides and nitrogen oxides, the method comprising the following steps:
cooling the flue gas at the outlet of the furnace,
placing the cooled flue gas in contact with a sulphur oxide neutralisation agent (28, 9), in order to reduce the sulphur oxides by desulphurisation reactions, and to obtain residues of the desulphurisation reactions,
separating (6) the residues of the desulphurisation reactions from the flue gas,
reheating at least one portion of the flue gas separated from the residues of the desulphurisation reactions,
injecting (26) a nitrogen oxide neutralisation agent into the reheated flue gas,
placing (6) at least the reheated flue gas and the nitrogen oxide neutralisation agent in contact with a catalyst, in order to reduce the nitrogen oxides by denitrification reactions, said cooling of the flue gas at the outlet of the furnace being carried out by reheating, inside the same heat exchanger (1), said at least one portion of the flue gas separated from the residues of the desulphurisation reactions,
wherein the reheated flue gas is mixed, after injecting (26) the nitrogen oxide neutralisation agent, with the flue gas cooled after being placed in contact with the sulphur oxide neutralisation agent (28, 9), the separation of the residues of the desulphurisation reactions and the placing in contact with said catalyst being carried out inside a single separation device (6).

2. A treatment method according to claim 1, wherein the sulphur oxide neutralisation agent is lime (28).

3. A treatment method according to claim 1, wherein when the cooled flue gas is placed in contact with the sulphur oxide neutralisation agent (28, 9), the moisture inside the flue gas is monitored (10, 22).

4. A treatment method according to claim 1, wherein a portion of the residues of the desulphurisation reactions is recycled as a sulphur oxide neutralisation agent.

5. A treatment method according to claim 1, wherein the nitrogen oxide neutralisation agent is ammonia.

6. A facility (100) for treating flue gas from a furnace, comprising sulphur oxides and nitrogen oxides, for performing the method according to claim 1, comprising a heat exchanger (1) connected to the furnace in order to cool the flue gas (11) exiting said furnace, a desulphurisation reactor (2) connected to the heat exchanger (1) and in which the cooled flue gas is placed in contact with a sulphur oxide neutralisation agent in order to reduce the latter by desulphurisation reactions, a separation device (6), connected to the desulphurisation reactor (2), in which the residues of the desulphurisation reactions are separated from the flue gas, an injector (26) of a nitrogen oxide neutralisation agent into at least one portion of the flue gas separated from the residues of the desulphurisation reactions, and a catalytic device (6) for denitrification of the flue gas, the device (6) for separating the residues of the desulphurisation reactions being connected to the heat exchanger (1) so that said at least one portion of the flue gas from the device (6) for separating the residues of the desulphurisation reactions is reheated by the flue gas exiting the furnace, wherein the device (6) for separating the residues of the desulphurisation reactions and the catalytic device (6) are combined in a single separation device (6), the reheated flue gas being mixed, after injecting the nitrogen oxide neutralisation agent, with the cooled flue gas exiting the reactor (2) in an inlet duct (14) of the separation device (6).

7. A treatment facility (100) according to claim 6, wherein the separation device (6) comprises at least one bag filter, a denitrification catalyst being distributed on the surface of the bags of the filter.

8. A treatment facility (100) according to claim 6, wherein the separation device (6) comprises at least one bag filter, a denitrification catalyst being placed inside the bags of the filter.

9. A treatment method according to claim 2, wherein when the cooled flue gas is placed in contact with the sulphur oxide neutralisation agent (28, 9), the moisture inside the flue gas is monitored (10, 22).

10. A treatment method according to claim 2, wherein a portion of the residues of the desulphurisation reactions is recycled as a sulphur oxide neutralisation agent.

11. A treatment method according to claim 3, wherein a portion of the residues of the desulphurisation reactions is recycled as a sulphur oxide neutralisation agent.

12. A treatment method according to claim 2, wherein the nitrogen oxide neutralisation agent is ammonia.

13. A treatment method according to claim 3, wherein the nitrogen oxide neutralisation agent is ammonia.

14. A treatment method according to claim 4, wherein the nitrogen oxide neutralisation agent is ammonia.

15. A facility (100) for treating flue gas from a furnace, comprising sulphur oxides and nitrogen oxides, for performing the method according to claim 2, comprising a heat exchanger (1) connected to the furnace in order to cool the flue gas (11) exiting said furnace, a desulphurisation reactor (2) connected to the heat exchanger (1) and in which the cooled flue gas is placed in contact with a sulphur oxide neutralisation agent in order to reduce the latter by desulphurisation reactions, a separation device (6), connected to the desulphurisation reactor (2), in which the residues of the desulphurisation reactions are separated from the flue gas, an injector (26) of a nitrogen oxide neutralisation agent into at least one portion of the flue gas separated from the residues of the desulphurisation reactions, and a catalytic device (6) for denitrification of the flue gas, the device (6) for separating the residues of the desulphurisation reactions being connected to the heat exchanger (1) so that said at least one portion of the flue gas from the device (6) for separating the residues of the desulphurisation reactions is reheated by the flue gas exiting the furnace, wherein the device (6) for separating the residues of the desulphurisation reactions and the catalytic device (6) are combined in a single separation device (6), the reheated flue gas being mixed, after injecting the nitrogen oxide neutralisation agent, with the cooled flue gas exiting the reactor (2) in an inlet duct (14) of the separation device (6).

16. A facility (100) for treating flue gas from a furnace, comprising sulphur oxides and nitrogen oxides, for performing the method according to claim 3, comprising a heat exchanger (1) connected to the furnace in order to cool the flue gas (11) exiting said furnace, a desulphurisation reactor (2) connected to the heat exchanger (1) and in which the cooled flue gas is placed in contact with a sulphur oxide neutralisation agent in order to reduce the latter by desulphurisation reactions, a separation device (6), connected to the desulphurisation reactor (2), in which the residues of the desulphurisation reactions are separated from the flue gas, an injector (26) of a nitrogen oxide neutralisation agent into at least one portion of the flue gas separated from the residues of the desulphurisation reactions, and a catalytic device (6) for denitrification of the flue gas, the device (6) for separating the residues of the desulphurisation reactions being connected to the heat exchanger (1) so that said at least one portion of the flue gas from the device (6) for separating the residues of the desulphurisation reactions is reheated by the flue gas exiting the furnace, wherein the device (6) for separating the residues of the desulphurisation reactions and the catalytic device (6) are combined in a single separation device (6), the reheated flue gas being mixed, after injecting the nitrogen oxide neutralisation agent, with the cooled flue gas exiting the reactor (2) in an inlet duct (14) of the separation device (6).

17. A facility (100) for treating flue gas from a furnace, comprising sulphur oxides and nitrogen oxides, for performing the method according to claim 4, comprising a heat exchanger (1) connected to the furnace in order to cool the flue gas (11) exiting said furnace, a desulphurisation reactor (2) connected to the heat exchanger (1) and in which the cooled flue gas is placed in contact with a sulphur oxide neutralisation agent in order to reduce the latter by desulphurisation reactions, a separation device (6), connected to the desulphurisation reactor (2), in which the residues of the desulphurisation reactions are separated from the flue gas, an injector (26) of a nitrogen oxide neutralisation agent into at least one portion of the flue gas separated from the residues of the desulphurisation reactions, and a catalytic device (6) for denitrification of the flue gas, the device (6) for separating the residues of the desulphurisation reactions being connected to the heat exchanger (1) so that said at least one portion of the flue gas from the device (6) for separating the residues of the desulphurisation reactions is reheated by the flue gas exiting the furnace, wherein the device (6) for separating the residues of the desulphurisation reactions and the catalytic device (6) are combined in a single separation device (6), the reheated flue gas being mixed, after injecting the nitrogen oxide neutralisation agent, with the cooled flue gas exiting the reactor (2) in an inlet duct (14) of the separation device (6).

18. A facility (100) for treating flue gas from a furnace, comprising sulphur oxides and nitrogen oxides, for performing the method according to claim 5, comprising a heat exchanger (1) connected to the furnace in order to cool the flue gas (11) exiting said furnace, a desulphurisation reactor (2) connected to the heat exchanger (1) and in which the cooled flue gas is placed in contact with a sulphur oxide neutralisation agent in order to reduce the latter by desulphurisation reactions, a separation device (6), connected to the desulphurisation reactor (2), in which the residues of the desulphurisation reactions are separated from the flue gas, an injector (26) of a nitrogen oxide neutralisation agent into at least one portion of the flue gas separated from the residues of the desulphurisation reactions, and a catalytic device (6) for denitrification of the flue gas, the device (6) for separating the residues of the desulphurisation reactions being connected to the heat exchanger (1) so that said at least one portion of the flue gas from the device (6) for separating the residues of the desulphurisation reactions is reheated by the flue gas exiting the furnace, wherein the device (6) for separating the residues of the desulphurisation reactions and the catalytic device (6) are combined in a single separation device (6), the reheated flue gas being mixed, after injecting the nitrogen oxide neutralisation agent, with the cooled flue gas exiting the reactor (2) in an inlet duct (14) of the separation device (6).

19. A facility (100) for treating flue gas from a furnace, comprising sulphur oxides and nitrogen oxides, for performing the method according to claim 9, comprising a heat exchanger (1) connected to the furnace in order to cool the flue gas (11) exiting said furnace, a desulphurisation reactor (2) connected to the heat exchanger (1) and in which the cooled flue gas is placed in contact with a sulphur oxide neutralisation agent in order to reduce the latter by desulphurisation reactions, a separation device (6), connected to the desulphurisation reactor (2), in which the residues of the desulphurisation reactions are separated from the flue gas, an injector (26) of a nitrogen oxide neutralisation agent into at least one portion of the flue gas separated from the residues of the desulphurisation reactions, and a catalytic device (6) for denitrification of the flue gas, the device (6) for separating the residues of the desulphurisation reactions being connected to the heat exchanger (1) so that said at least one portion of the flue gas from the device (6) for separating the residues of the desulphurisation reactions is reheated by the flue gas exiting the furnace, wherein the device (6) for separating the residues of the desulphurisation reactions and the catalytic device (6) are combined in a single separation device (6), the reheated flue gas being mixed, after injecting the nitrogen oxide neutralisation agent, with the cooled flue gas exiting the reactor (2) in an inlet duct (14) of the separation device (6).

20. A facility (100) for treating flue gas from a furnace, comprising sulphur oxides and nitrogen oxides, for performing the method according to claim 10, comprising a heat exchanger (1) connected to the furnace in order to cool the flue gas (11) exiting said furnace, a desulphurisation reactor (2) connected to the heat exchanger (1) and in which the cooled flue gas is placed in contact with a sulphur oxide neutralisation agent in order to reduce the latter by desulphurisation reactions, a separation device (6), connected to the desulphurisation reactor (2), in which the residues of the desulphurisation reactions are separated from the flue gas, an injector (26) of a nitrogen oxide neutralisation agent into at least one portion of the flue gas separated from the residues of the desulphurisation reactions, and a catalytic device (6) for denitrification of the flue gas, the device (6) for separating the residues of the desulphurisation reactions being connected to the heat exchanger (1) so that said at least one portion of the flue gas from the device (6) for separating the residues of the desulphurisation reactions is reheated by the flue gas exiting the furnace, wherein the device (6) for separating the residues of the desulphurisation reactions and the catalytic device (6) are combined in a single separation device (6), the reheated flue gas being mixed, after injecting the nitrogen oxide neutralisation agent, with the cooled flue gas exiting the reactor (2) in an inlet duct (14) of the separation device (6).
